(19) United States
(12) Patent Application Publication
(10) Pub. No.: US 2017/0099806 A1
(43) Pub. Date: Apr. 13, 2017

(54) POWERED ANAMIAL BRUSH

(71) Applicant: Todd Matthew Kramer, Vassar, MI (US)

(72) Inventor: Todd Matthew Kramer, Vassar, MI (US)

(21) Appl. No.: 14/881,689

(22) Filed: Oct. 13, 2015

(51) Int. Cl. A01K 13/00

(52) U.S. Cl. CPC A01K 13/002

(57) ABSTRACT

A powered animal brush for animal grooming is disclosed. The brush consists of removable and replaceable elongated combs that lock into a central housing. These combs insert into the outside surface of the central housing and groom the animals as the combs rotate.

### BACKGROUND OF THE INVENTION

Brushes for animal grooming are not new to the art. However, an animal brush that rotates and has removable bristles is.

In U.S. Pat. No. 8,573,231 issued to Ragosta on Nov. 5, 2013 entitled, “Hair Styling Tool With Moveable Dividers”, teaches a hair styling tool having a plurality of bristles and one or more moveable members extending radially outward from the core and moveable between opposing positions. The moveable members move between a retractable position where the divider is fitted between, and even with, or slightly above, or slightly below, the bristles, to engage hair, and an extended position where the divider is moved out beyond the bristles to disengage the hair from the bristles. The hair styling tool having the moveable member which engages and disengages the hair with bristles minimizes tangling of the hair while brushing. The hair styling tool may be a rotating brush optionally equipped with a motor.

This prior art is limited in that the moveable members are only moveable between opposing positions. The present invention allows the bristle portion to be removed from the brush itself for cleaning and replacement.

U.S. Pat. No. 6,098,635 issued to Marion on Aug. 8, 2000 entitled, “Motorized, Rotating Hair Brush”, teaches a rotating hair brush having several dividers between some of the rows of bristles. The dividers prevent hair from being tangled in the bristles as the brush rotates. The dividers also help smooth the hair and absorb and transfer heat back to the hair from a blow dryer. The dividers may be of many different shapes and may extend longitudinally or curve along the brush. Structures allow the brush to be removed from the handle that contains the motor and the battery that powers the brush. The brush also may have a guide covering part of the bristles.

This prior art is limited in that it does not have removable bristles and the entire head of the device is removable from the motorized part. The present invention has removable bristles and it is also motorized.

U.S. Pat. No. 5,584,088 issued to Pauldine entitled, “Rotating Hair Brush”, teaches a rotating hair brush comprised of a handle portion having a detent projection formed on an end portion thereof and a slot formed in an opposing side therefrom. A rotating brush portion has a plurality of bristles extending radially there-around. The rotating brush portion has a shaft portion dimensioned to be rotatably received within the handle portion. A rotation lock position has a shaft portion dimensioned to be received within a handle portion. The shaft portion has a detent and a second detent formed therein. The first detent and the second detent selectively cooperate with the detent projection of the handle portion.

Once again, this prior art is very limited in that it does not provide for removable bristles.

### THE INVENTION

The present invention is a powered animal brush. The powered animal brush comprises a central cylindrical housing that has a first and a second flat end. The first flat end has a centrally located drive shaft projecting therefrom. The central cylindrical housing has at least two elongated channels located in an outside surface and running from the first flat end to the second flat end. Each channel terminates in a lock opening. There are at least two elongated combs. Each elongated comb has a back and a plurality of teeth projecting from the back. Each of the combs has a lock peg located thereon. The back of each comb is inserted in the elongated channel such that the lock projection inserts into a respective lock opening.

### BRIEF DESCRIPTION OF THE DRAWINGS

FIG. 1 shows the powered animal brush from the side.

FIG. 2 shows an elongated comb from the side.

FIG. 3 shows the central cylindrical housing from the side.

### DETAILED DESCRIPTION OF THE DRAWINGS

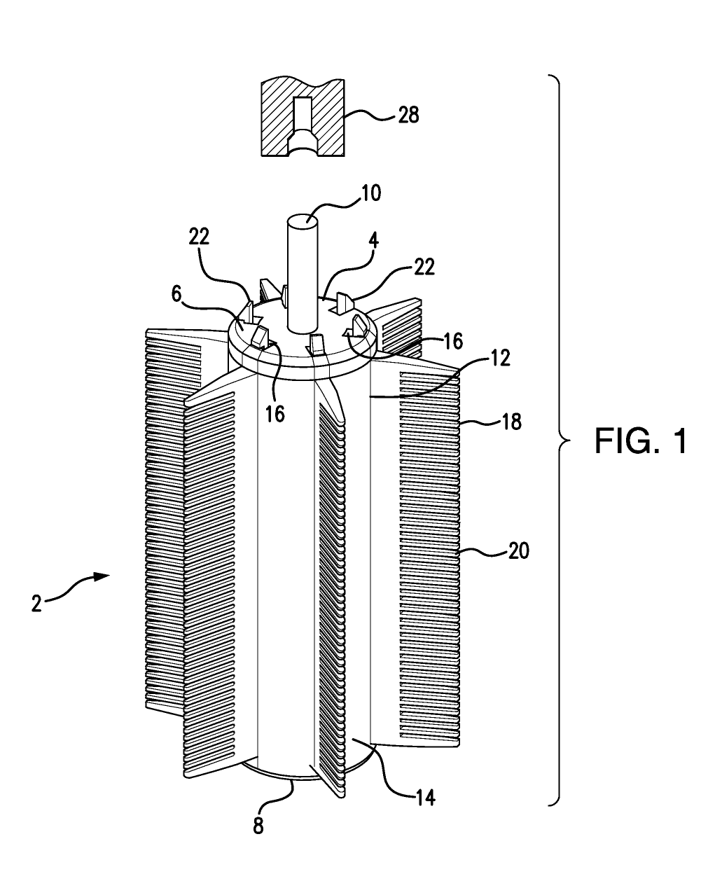

FIG. 1 shows the powered animal brush 2 from the side. The powered animal brush 2 consists of a central cylindrical housing 4, a first flat end 6 and a second flat end 8. The first flat end 6 has a drive shaft 10 extending from it. The central cylindrical housing 4 has elongated channels 12 formed in its outside surface 14. The first flat end 6 also has lock openings 16. The elongated channels 12 in the outside surface 14 of the central cylindrical housing 4 accept elongated combs 18. The elongated combs 18 have a plurality of teeth 20. The elongated combs 18 have locking pegs 22 that lock into the lock openings 16 to firmly secure the elongated combs into the central cylindrical housing 4. The drive shaft 10 is inserted into a motorized handle 28.

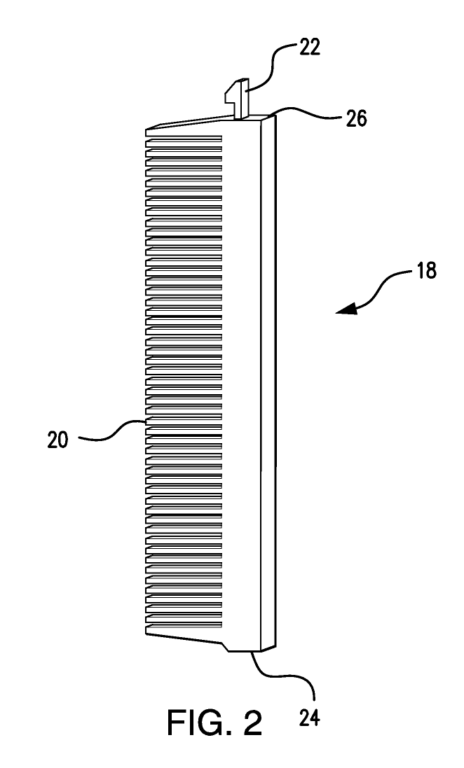

FIG. 2 shows an elongated comb 18 from the side. The elongated comb 18 has a plurality of teeth 20. The elongated comb 18 has a near end 24 and a distal end 26. The distal end 26 has a locking peg 22. When the elongated combs 18 are inserted into the central cylindrical housing 4 the locking peg 22 inserts into the lock opening 16 of the first flat end 6 and locks the elongated comb 18 into place within the central cylindrical housing 4.

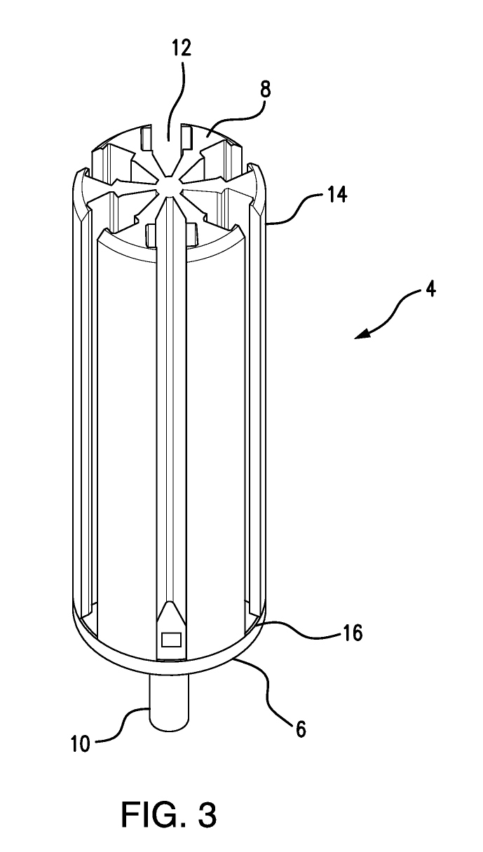

FIG. 3 shows the central cylindrical housing 4 from the side. The central cylindrical housing 4 has a first flat end 6 and a second flat end 8. The first flat end 6 has a drive shaft 10 extending from it. The central cylindrical housing 4 has plurality of elongated channels 12 in its outside surface 14 that accepts the elongated combs 18.

The powered animal brush 2 is powered by a cordless drill.

What is claimed is:

1. A powered animal brush, said powered animal brush comprising:
i. a central cylindrical housing having a first and a second flat end;
ii. said first flat end having a centrally located drive shaft projecting therefrom;
iii. said central cylindrical housing having at least two elongated channels located in an outside surface, running from said first flat end to said second flat end, each said channel terminating in a lock opening;
iv. at least two elongated combs, each having a back and a plurality of teeth projecting from said back, each said comb having a lock peg located thereon;
v. said back of each said comb being inserted in a said elongated channel such that said lock projection inserts into a respective said lock opening.
